(19) United States
(12) Patent Application Publication
(10) Pub. No.: US 2012/0281048 A1
(43) Pub. Date: Nov. 8, 2012

(54) PATTERN FORMING APPARATUS

(75) Inventor: Kunio Hakkaku, Nagano (JP)

(73) Assignee: MIMAKI ENGINEERING CO., LTD., NAGANO (JP)

(21) Appl. No.: 13/521,054

(22) PCT Filed: Jan. 20, 2010
(86) PCT No.: PCT/JP2010/000292

§ 371 Date: Jul. 9, 2012

(51) Int. Cl. B41J 2/01

(52) U.S. Cl. 347/101

(57) ABSTRACT

To provide a pattern forming apparatus whose operation is restrained in minimum and whose space saving and energy saving can be attained. The printer 10 is provided with an ink jet head 11 for ejecting ink to a medium 20 to perform pattern formation, a UV lamp 15 for irradiating ultraviolet light for modifying surface to the medium 20, and an integral support part 13 which supports both of the ink jet head 11 and the UV lamp 15.

### TECHNICAL FIELD

The present invention relates to a pattern forming apparatus in which liquid is ejected to a pattern to-be-formed body to form pattern formation.

### BACKGROUND ART

Various types of pattern forming apparatuses have been known in which liquid is ejected to a pattern to-be-formed body to perform pattern formation. The pattern forming apparatuses include a semiconductor manufacturing apparatus for forming a resist pattern and an ink jet printer for forming an image pattern. In the various types of pattern forming apparatuses, for example, in a case of an ink jet printer, ink is ejected to a medium (pattern to-be-formed body) from a head for ejecting ink to form a pattern. In a technique for performing such pattern formation, it has been known as an effective means that irradiation of ultraviolet light is performed on a surface of the medium for modifying the surface of the medium. For example, when irradiation of ultraviolet light is performed on a medium before pattern formation and the property of a surface of the medium is modified, wettability of the ink to the medium is effectively improved at the time of pattern formation afterwards. Therefore, a pattern forming apparatus has been also proposed which is provided with a means for irradiating ultraviolet light.

### CITATION LIST

### Patent Literature

[Patent Literature 1] Japanese Patent Laid-Open No. Hei 8-311782

### SUMMARY OF INVENTION

### Technical Problem

However, in the conventional pattern forming apparatus, although a means for irradiating ultraviolet light is provided, the irradiating means and a head for ejecting ink are separated from each other and wide ranges are required for the respective operations. Therefore, the size of the apparatus is increased, excessive space is required for installing the apparatus, and positioning of the pattern and timing matching are required.

In view of the problem described above, an objective of the present invention is to provide a pattern forming apparatus whose operation can be restrained in minimum even when the pattern forming apparatus is provided with a means for irradiating ultraviolet light for modifying surface of a medium and which is capable of attaining space saving simultaneously.

### Solution to Problem

In order to attain the above-mentioned objective, the pattern forming apparatus in accordance with the present invention is provided with the following Feature 1 as a main feature point and may be also provided with Features 2 through 5.

(Feature 1) A pattern forming apparatus includes an ultraviolet irradiation means structured to irradiate ultraviolet light for modifying surface of a pattern to-be-formed body to the pattern to-be-formed body, a liquid ejecting means structured so that liquid is ejected to the pattern to-be-formed body to perform pattern formation, and an integral support part which supports both of the liquid ejecting means and the ultraviolet irradiation means.

In this specification, the “surface of a pattern to-be-formed body” is a region where a pattern is to be formed on a surface of an object on which the pattern is to be formed, or the entire surface of the object on which the pattern is to be formed. Further, in a pattern to-be-formed body on which patterns have been already formed by using liquids once or several times, a region where a pattern is further to be formed or the entire surface may be included.

(Feature 2) In the pattern forming apparatus in accordance with Feature 1, the liquid is ink and the liquid ejecting means is an ink jet head.

(Feature 3) In the case of Feature 2, the ink jet head is a line type ink jet head which is provided with nozzles for ejecting ink which are disposed in a line-like shape.

(Feature 4) In Feature 2 or 3, the integral support part is moved on an upper side with respect to the pattern to-be-formed body and, during a moving operation of the integral support part, the ultraviolet irradiation means irradiates ultraviolet light to the pattern to-be-formed body and the ink jet head performs pattern formation on the pattern to-be-formed body.

(Feature 5) In Feature 2 or 3, the pattern to-be-formed body is moved on a lower side with respect to the integral support part and, during a moving operation of the pattern to-be-formed body, the ultraviolet irradiation means irradiates ultraviolet light to the pattern to-be-formed body and the ink jet head performs pattern formation on the pattern to-be-formed body.

Further, the pattern forming apparatus in accordance with the present invention may be also further provided with following Features 6 through 18 as described in detail below in “Description of Embodiments”.

(Feature 6) A plurality of ink jet heads is disposed in parallel.

(Feature 7) The ultraviolet irradiation means is provided with a plurality of ultraviolet light source lamps whose lengths are different from each other and an ultraviolet light control section which controls lighting of the ultraviolet light source lamps so that ultraviolet light is irradiated in a range corresponding to a shape of a pattern which is formed on the pattern to-be-formed body.

(Feature 8) The ultraviolet light control section controls at least one of a light emitting amount or a light emitting time of the ultraviolet light source lamp.

(Feature 9) A flexible member for shielding the ultraviolet light is provided on a side where the ultraviolet light is irradiated from the ultraviolet irradiation means.

(Feature 10) The ultraviolet irradiation means is a low pressure mercury lamp which emits ultraviolet light with a wavelength of 300 nm or less.

(Feature 11) The ultraviolet irradiation means is an excimer lamp which emits light with a wavelength of 200 nm or less.

(Feature 12) The ink is ultraviolet curing type ink and a light source which emits light with a wavelength of 300 nm or more for curing the ink is provided in the vicinity of the ink jet head.

(Feature 13) An endless belt for holding and feeding a pattern to-be-formed body is provided.

(Feature 14) An immersing treatment part in which a pattern to-be-formed body is brought into contact with solvent is provided before irradiation of ultraviolet rays and pattern formation are performed.

(Feature 15) In the case of Feature 14, a heating treatment part for preheating the pattern to-be-formed body is provided before the pattern to-be-formed body is brought into contact with the solvent.

(Feature 16) The irradiation of ultraviolet light and the pattern formation are simultaneously performed on the pattern to-be-formed body.

(Feature 17) The pattern formation is performed on the pattern to-be-formed body after the irradiation of ultraviolet light is performed.

(Feature 18) The irradiation of ultraviolet rays is performed on the pattern to-be-formed body after the pattern formation is performed.

The irradiation of ultraviolet light after pattern formation is performed for modifying the surface on which pattern is to be formed as preparation for the succeeding process.

### Advantageous Effects of Invention

The pattern forming apparatus in accordance with the present invention is provided with the integral support part which supports both of the liquid ejecting means and the ultraviolet irradiation means and thus the size of the pattern forming apparatus can be reduced and space saving of the pattern forming apparatus can be attained. Further, the operation of the apparatus can be restrained in a reduced range and thus energy saving of the pattern forming apparatus can be attained.

### BRIEF DESCRIPTION OF DRAWINGS

FIGS. 1(a) and 1(b) are schematic views for explaining a structure of a pattern forming apparatus in accordance with a first embodiment of the present invention.

FIG. 2 is a block diagram for explaining an operation of a pattern forming apparatus in accordance with the present invention.

FIGS. 3(a) and 3(b) are schematic views for explaining a structure of a pattern forming apparatus in accordance with a second embodiment of the present invention.

FIGS. 4(a) and 4(b) are schematic views for explaining a modified structure of a pattern forming apparatus in accordance with the second embodiment of the present invention.

FIG. 5 is a schematic explanatory view showing an example in which a plurality of line heads is disposed.

FIGS. 6(a) and 6(b) are schematic views for explaining a structure of a pattern forming apparatus in accordance with a third embodiment of the present invention.

FIGS. 7(a) and 7(b) are schematic views for explaining a structure of a pattern forming apparatus in accordance with a fourth embodiment of the present invention.

FIG. 8 is a schematic view for explaining a structure of a pattern forming apparatus in accordance with a fifth embodiment of the present invention.

FIG. 9 is a schematic view for explaining a structure of a pattern forming apparatus in accordance with a sixth embodiment of the present invention.

FIG. 10 is a schematic view for explaining a structure of a pattern forming apparatus in accordance with a seventh embodiment of the present invention.

### DESCRIPTION OF EMBODIMENTS

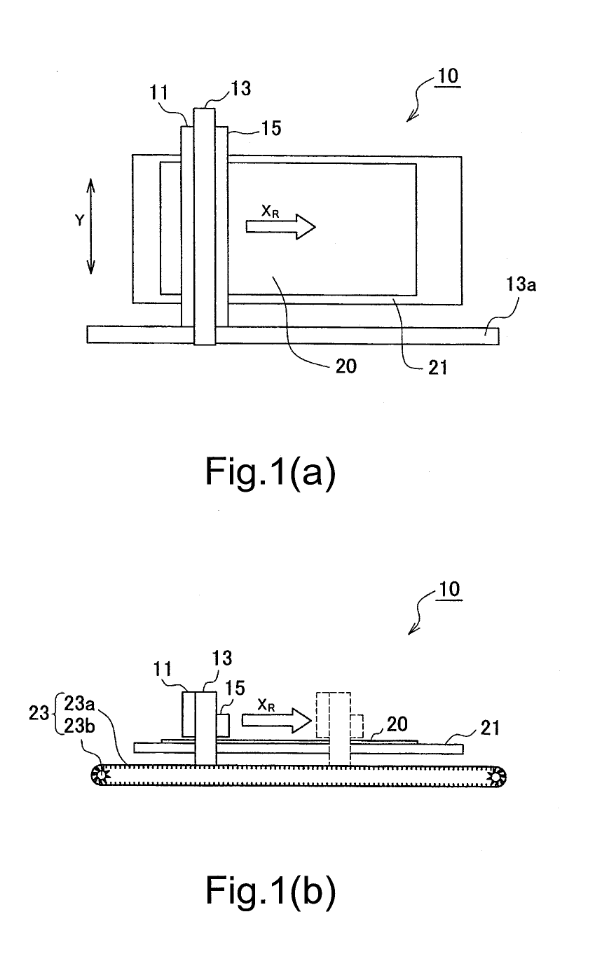

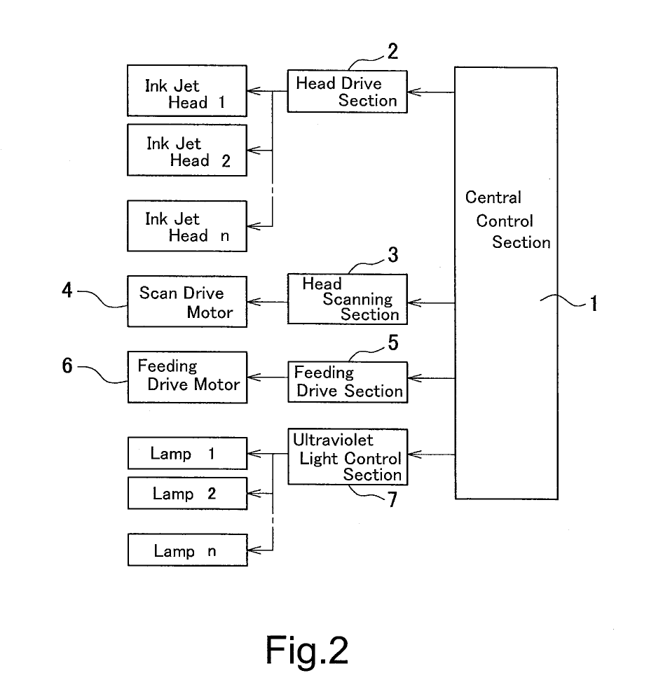

Embodiments of the present invention will be described below with reference to the accompanying drawings. In the embodiments, a pattern forming apparatus in accordance with the present invention is applied to an ink jet printer. FIGS. 1(a) and 1(b) are schematic structure views for explaining a pattern forming apparatus in accordance with a first embodiment of the present invention. Especially, FIG. 1(a) is a schematic plan view showing an example of a pattern forming apparatus and FIG. 1(b) is its front view. In the following drawings, the figures indicated with (a) and (b) are represented according to the same relationship. Further, FIG. 2 is a block diagram for explaining operations of the pattern forming apparatuses in accordance with a first through a fifth embodiments of the present invention.

In FIG. 1, “10” is an ink jet printer (pattern forming apparatus, hereinafter, also simply referred to as a printer), “11” is a line type inkjet head (liquid ejecting means, hereinafter, also referred to as a line head or simply a head), “13” is an integral support part, “13a” is a guide member, “15” is a UV lamp unit (ultraviolet irradiation means), and “20” is a medium (pattern to-be-formed body). Further, “21” is a medium holding part and “23” is a feeding means which is structured of a feeding belt 23a and pulleys 23b. The arrow “XR” in the drawings indicates a direction in which the head 11 scans a medium. Further, the arrow “Y” indicates an arrangement direction of nozzles (not shown) for ejecting ink which are provided in the line head 11.

The line head 11 and the UV lamp unit 15 are schematically formed in a rectangular prism-like shape having about the same length or a little longer than a width in the “Y” direction of the medium 20 and are disposed on an upper side of the medium 20 in a tightly contacted and supported state with both side faces of the integral support part 13 having the similar shape. The integral support part 13 is supported so as to be movable on an upper side of the medium 20 along the guide member 13a. In this embodiment, the integral support part 13 is mechanically structured so as to be movable in a reciprocated manner. The guide member 13a has a length so that the integral support part 13 is capable of reciprocating on a medium 20 in a required range. Further, the integral support part 13 is arranged on the feeding belt 23a of the feeding means 23. The guide member 13a is not shown in FIG. 1(b).

The UV lamp unit 15 is provided with a lamp structured to emit ultraviolet light in its inside. In a fifth embodiment described below, a plurality of ultraviolet light source lamps whose lengths are different from each other is used. The lamp which is used emits ultraviolet light with a wavelength of about 185 to 254 nm which is suitable for modifying the surface of a medium 20. In a case that a medium 20 is a pattern to-be-formed body made of resin for commonly performing ink-jet printing, when ultraviolet light with a wavelength of about 185 to 254 nm is irradiated on a medium, the “C-C” bond of organic substance of a medium surface itself or adhered to the surface is cut and decomposed by the ultraviolet light and, in addition, oxidation is occurred due to ozone (O₃) generated by the ultraviolet light. The medium surface modified in this manner is provided with the effect that wettability of ink is improved. Further, the effect is also obtained that organic substance on the surface of the medium 20 is washed. In this embodiment, a low pressure mercury lamp which emits ultraviolet light with a wavelength of 300 nm or less, an excimer lamp which emits ultraviolet light with a wavelength of 200 nm or less, or the like is used.

The medium 20 is placed on the medium holding part 21. An air suction means not shown is provided in an inside of the medium holding part 21 and the medium 20 is sucked by the air suction means and held on the medium holding part 21 in an immovable state.

Next, in FIG. 2, “1” is a central control section such as a CPU and “2” is a head drive section. A head scanning section 3 and a scan drive motor 4 structure a mechanism for driving a small ink jet head described below. “5” is a feeding drive section, “6” is a feeding drive motor and “7” is an ultraviolet light control section.

Next, an example of operation of the printer 10 will be described below.

The central control section 1 transmits a signal to the feeding drive section 5 and the feeding drive motor 6 is driven and thus, the pulley 23b of the feeding means 23 is operated to feed the feeding belt 23a in an “XR” direction and its opposite direction. In this case, the integral support part 13 arranged on the feeding belt 23a is reciprocated along the guide member 13a on an upper side of the medium 20 in a state that both of the line head 11 and the UV lamp unit 15 are integrally supported.

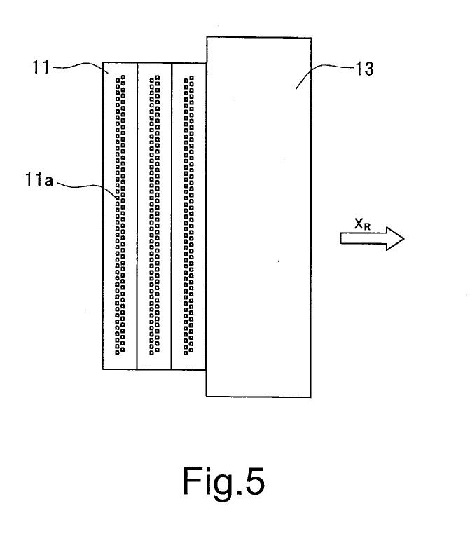

Ink is ejected from the head 11 by the head drive section 2 which receives a signal from the central control section 1 during reciprocating operation to form a desired pattern on the medium 20. As shown as the ink jet heads (1, 2 . . . n) in FIG. 2, in a case that a plurality of heads 11 is arranged in parallel manner like an example shown in FIG. 5 described below, the head drive section 2 receives signals from the central control section 1 to drive the respective heads 11 (1, 2 . . . n). Further, the ultraviolet light control section 7 which receives a signal from the central control section 1 controls lighting of a lamp in the UV lamp unit 15 and thereby ultraviolet light with a wavelength of 300 nm or less is irradiated under a preferred condition to the medium 20 to modify the surface of the medium 20. In this case, as shown as the lamps (1, 2 . . . n) in FIG. 2, when the UV lamp unit 15 is structured of a plurality of lamps like the fifth embodiment of the present invention described below, the ultraviolet light control section 7 controls the respective lamps (1, 2 . . . n). Irradiation of the ultraviolet light is performed during a preferred time according to the medium 20.

As described above, in the printer 10 in accordance with the first embodiment of the present invention, both of the line head 11 and the UV lamp unit 15 are operated in a integrally supported state by the integral support part 13 and thus an operation range can be minimized and energy saving can be attained. Further, a space of the entire apparatus can be set in a size in which only a mechanical margin is added to the size of the medium and thus the size of the apparatus can be reduced and space saving can be attained.

The pattern formation and irradiation of the ultraviolet light are performed in an appropriate order depending on the purpose. For example, in the printer 10, irradiation of the ultraviolet light and pattern formation can be simultaneously performed on the medium 20 while the integral support part 13 is scanned in the “XR” direction. In this case, working time can be shortened and working efficiency can be enhanced.

Further, pattern formation can be performed after the ultraviolet light is irradiated. In this case, first, while the integral support part 13 is reciprocated in the “XR” direction and the opposite direction, in a forward path, irradiation of the ultraviolet light is performed on the medium 20 for a predetermined time and, in a return path, ink is ejected from the line head 11 to form a desired pattern on the medium 20. According to this structure, in a case of a medium whose irradiation time of ultraviolet light is required to be longer than a pattern forming time, work can be performed efficiently and energy saving can be further attained.

Further, irradiation of ultraviolet light can be performed after the pattern is formed. In this case, first, while the integral support part 13 is reciprocated in the “XR” direction and the opposite direction, in a forward path, ink is ejected from the line head 11 to form a desired pattern on a medium 20 and, in a return path, irradiation of the ultraviolet light is performed on the medium 20 for a predetermined time period. According to this structure, in a case that modifying of a surface of the medium 20 is performed after a pattern is formed, work can be performed efficiently.

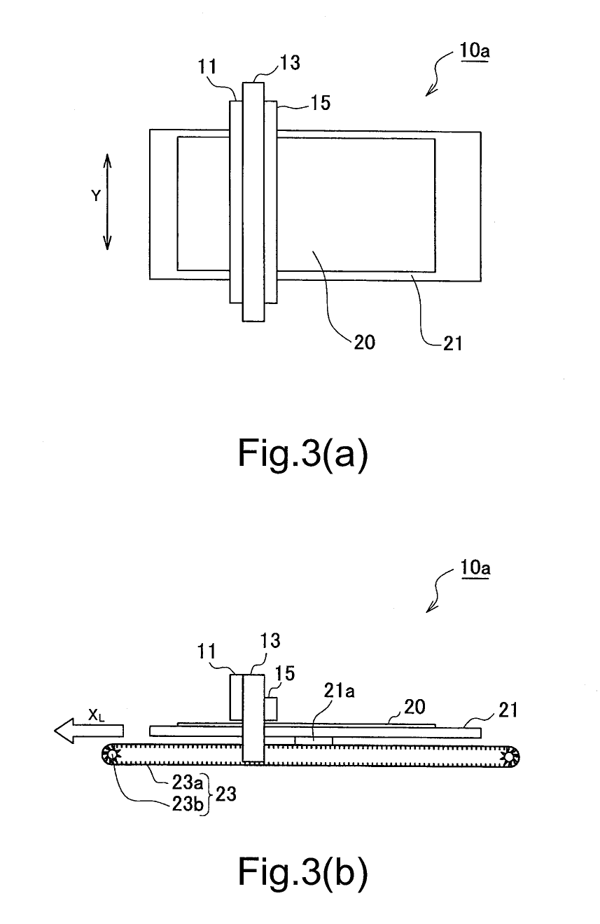

Next, a pattern forming apparatus in a second embodiment of the present invention will be described below with reference to FIGS. 3(a) and 3(b). In the second embodiment, the basic structure is similar to the printer 10 in the first embodiment but its operation is different.

In FIGS. 3(a) and 3(b), “10a” is a printer. “21a” is a member which supports a medium holding part 21. The arrow “XL” in the drawing indicates a direction in which the medium holding part 21 is moved. In the second embodiment, the integral support part 13 is fixed. Further, the member 21a is attached to a feeding belt 23a of a feeding means 23. Other structures are similar to the first embodiment.

Next, an example of operation of the printer 10a will be described below with reference to FIG. 2 and FIGS. 3(a) and 3(b).

The central control section 1 transmits a signal to the feeding drive section 5 and the feeding drive motor 6 is driven and thus, the pulley 23b of the feeding means 23 is operated to feed the feeding belt 23a in an “XR” direction and its opposite direction. In this case, the member 21a which is arranged on the feeding belt 23a is reciprocatedly moved together with the holding part 21 in a state that the medium 20 is placed on an under side of the integral support part 13 and the head 11 and the UV lamp unit 15 which are supported by the integral support part 13.

Ink is ejected from the head 11 (in FIG. 2, ink jet heads 1, 2 . . . n) by the head drive section 2 which receives a signal from the central control section 1 during the reciprocating operation to form a desired pattern on the medium 20. Further, the ultraviolet light control section 7 which receives a signal from the central control section 1 controls lighting of a lamp (in FIG. 2, lamps 1, 2 . . . n) in the UV lamp unit 15 and thereby ultraviolet light with a wavelength of 300 nm or less is irradiated to the medium 20 under a preferred condition to modify the surface of the medium 20.

The order and the like of the pattern formation and irradiation of the ultraviolet light can be appropriately set similarly to the first embodiment.

In the printer 10 in accordance with the first embodiment, the integral support part 13 is reciprocatedly moved in a state that the medium 20 is stationary. On the other hand, in the printer 10a in accordance with the second embodiment, the integral support part 13 is fixed and the medium 20 is reciprocatedly moved and thereby the pattern formation and irradiation of the ultraviolet light to the medium 20 are performed. Compared with the printer 10, although the printer 10a requires space so that the holding part 21 is capable of moving in the “XL” direction, operations of pattern formation and irradiation of the ultraviolet light can be performed in a state that the integral support part 13 is fixed and thus reliability of the apparatus is enhanced. In other words, the ink jet head 11, the UV lamp unit 15, electrical members relating to the ink jet head 11 and the UV lamp unit 15, an exhaust port of ozone (see the fifth embodiment) caused by the UV lamp unit 15 and the like are fixed and thus functional deterioration is reduced and a pattern forming apparatus with a high degree of reliability can be obtained. Further, like a seventh embodiment described below, in a case that a pattern forming apparatus is used in processes that other processes are provided in its front and rear positions, the processing on a medium can be performed as one process among processes through which the medium is fed and thus work can be performed efficiently.

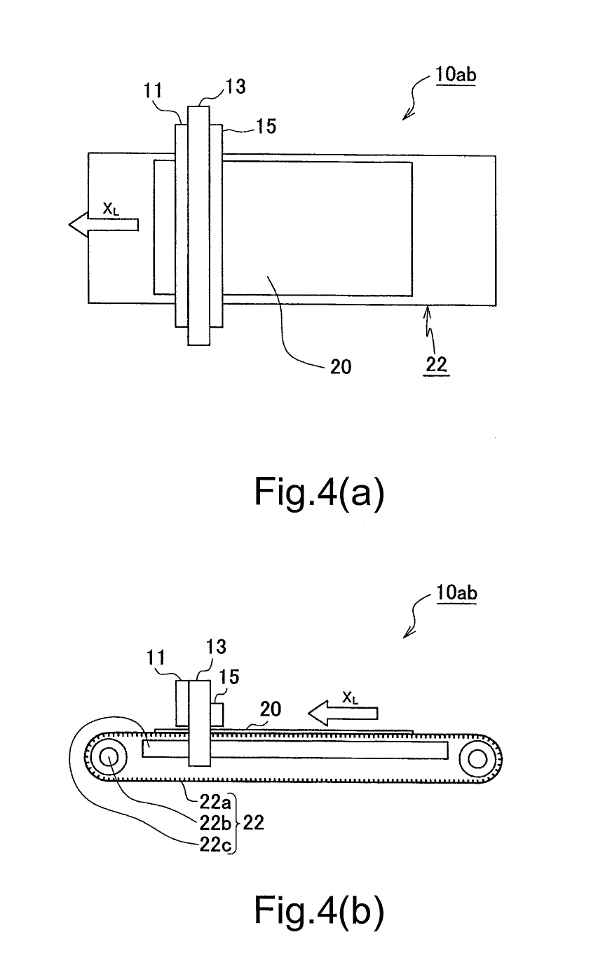

Next, a pattern forming apparatus in accordance with a modified example of the second embodiment of the present invention will be described below with reference to FIGS. 4(a) and 4(b).

In FIGS. 4(a) and 4(b), “10ab” is a printer. “22” is a holding part and feeding means, “22a” is an endless belt, “22b” is a feeding pulley, and “22c” is an air suction unit. The arrow “XL” in the drawing indicates a direction in which a medium 20 is fed. The medium 20 is placed on the endless belt 22a of the holding part and feeding means 22. The air suction unit 22c is provided on an inner side of the endless belt 22a and the medium 20 is held on the endless belt 22a in a state that the medium 20 is sucked. Other structures are similar to the printer 10a in the second embodiment. Further, its operation is similar to the printer 10a. However, in the printer 10ab in this modified example, since the endless belt 22c is used, a function of feeding and holding of the medium 20 is attained by one structure and thus the structure of the apparatus can be simplified and the size and space of the apparatus can be reduced.

Also in the case of the printer 10ab, similarly to the second embodiment, pattern formation and irradiation of the ultraviolet light to the medium 20 can be performed in a state that the integral support part 13 is fixed. Therefore, functional deterioration can be reduced and a pattern forming apparatus with a high degree of reliability can be obtained. Further, like a seventh embodiment described below, in a case that a pattern forming apparatus is used in processes that other processes are provided in its front and rear positions, the processing on a medium can be performed as one process among processes through which the medium is fed and thus work can be performed efficiently.

In the printers 10, 10a and 10ab, a plurality of line heads 11 may be disposed in parallel. FIG. 5 is a schematic plan view showing an arrangement of a case that three line heads 11 are provided in which the integral support part 13 and three lines of the line head 11 supported by the integral support part 13 are viewed from the ink ejection face side. “11a” is a nozzle which is disposed in a line shape for ejecting ink from the head 11. When a plurality of the ink jet heads 11 is disposed in parallel as described above, plural types of ink can be ejected and formation of an image using plural colors and formation of plural multilayered patterns whose functions are different can be performed.

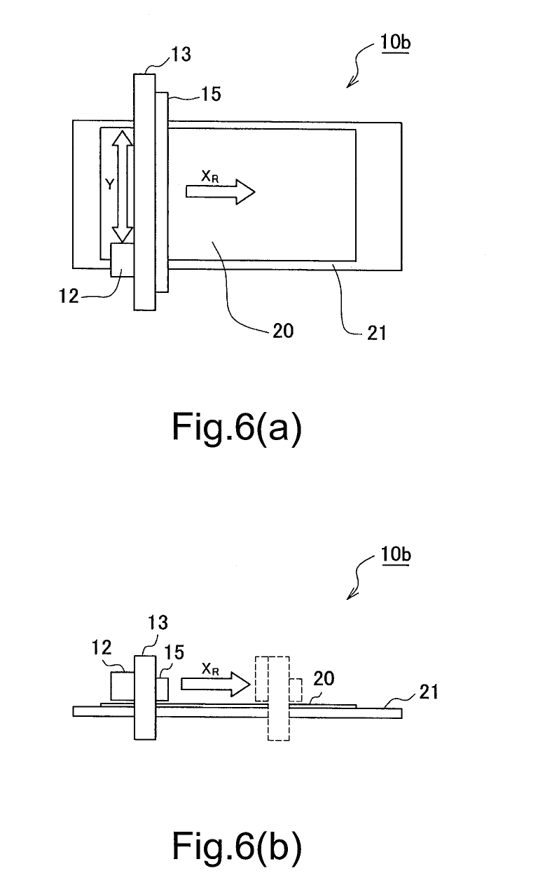

Next, a pattern forming apparatus in a third embodiment of the present invention will be described below with reference to FIGS. 6(a) and 6(b). In the third embodiment, a basic structure of the apparatus is similar to the first embodiment but a liquid ejecting means is a small ink jet head instead of a so-called line type ink jet head. The arrow “XR” in the drawing indicates a direction in which the integral support part 13 is reciprocatedly moved on an upper side of a medium. Further, the arrow “Y” indicates a direction in which the head is reciprocatedly moved along the integral support part 13.

In FIGS. 6(a) and 6(b), “10b” is a printer (pattern forming apparatus). “12” is an ink jet head (liquid ejecting means; hereinafter, also simply referred to as a head). The ink jet head 12 is supported by a part of a side face of the integral support part 13 formed in a rectangular prism-like shape having about the same length or a little longer than a width in the “Y” direction of the medium 20 so as to be reciprocatedly moved along the integral support part 13 in the “Y” direction. Further, an UV lamp unit 15 is supported in a tightly contacted state on the other side face of the integral support part 13 and the head 12, the integral support part 13 and the UV lamp unit 15 are disposed on the upper side of the medium 20. The medium 20 is placed on the medium holding part 21.

Next, an example of operation of the printer 10b will be described below with reference to FIG. 2 and FIGS. 6(a) and 6(b).

The central control section 1 transmits a signal to the feeding drive section 5 to drive the feeding drive motor 6 and thereby a preferred feeding means not shown is operated. As a result, the integral support part 13 is reciprocatedly moved in the “XR” direction and its opposite direction on an upper side of the medium 20 in a state that both of the head 12 and the UV lamp unit 15 are integrally supported by the integral support part 13. The head scanning section 3 which receives a signal from the central control section 1 drives the scan drive motor 4 during the reciprocating operation and thereby the head 12 is also reciprocatedly moved in the “Y” direction along the integral support part 13 as needed. During the above-mentioned two reciprocated operations of the integral support part 13 and the head 12, ink is ejected from the head 12 by the head drive section 2 which receives a signal from the central control section 1 to form a desired pattern on the medium 20. Further, the ultraviolet light control section 7 which receives a signal from the central control section 1 controls lighting of a lamp (in FIG. 2, lamps 1, 2 . . . n) in the UV lamp unit 15 and thereby ultraviolet light with a wavelength of 300 nm or less is irradiated to the medium 20 under a preferred condition to modify the surface of the medium 20.

The order and the like of the pattern formation and irradiation of the ultraviolet light can be appropriately set similarly to the first embodiment.

As described above, in the printer 10b, both of the head 12 and the UV lamp unit 15 are operated in an integrally supported state and thus, similarly to the first embodiment, the operation can be minimized and energy saving can be attained. Further, a space of the entire apparatus can be set in a size in which only a mechanical margin is added to the size of the medium and thus the size of the apparatus can be reduced and space saving can be attained.

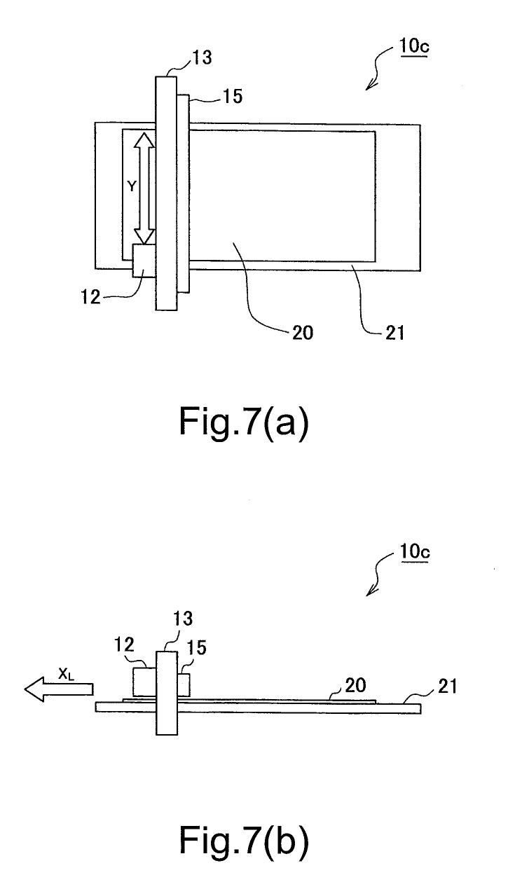

Next, a pattern forming apparatus in a fourth embodiment of the present invention will be described below with reference to FIGS. 7(a) and 7(b). In the fourth embodiment, the basic structure is similar to the printer 10b in the third embodiment but its operation is different. In FIGS. 7(a) and 7(b), “10c” is a printer. The arrow “XL” in the drawing indicates a direction in which the medium holding part 21 is moved. The integral support part 13 is fixed in the fourth embodiment. Other structures are similar to the third embodiment.

Next, an example of operation of the printer 10c will be described below with reference to FIG. 2 and FIGS. 7(a) and 7(b).

The central control section 1 transmits a signal to the feeding drive section 5 to drive the feeding drive motor 6 and thereby a preferred feeding means not shown is operated. As a result, the holding part 21 is reciprocatedly moved on a lower side of the integral support part 13 and the head 12 and the UV lamp unit 15 supported by the integral support part 13 in a state that a medium 20 is placed on the holding part 21. The head scanning section 3 which receives a signal from the central control section 1 drives the scan drive motor 4 during the reciprocating operation and thereby the head 12 is also reciprocatedly moved in the “Y” direction along the integral support part 13 as needed. During the above-mentioned two reciprocated operations of the integral support part 13 and the head 12, ink is ejected from the head 12 (in FIG. 2, ink jet heads 1, 2 . . . n) by the head drive section 2 which receives a signal from the central control section 1 to form a desired pattern on the medium 20. Further, the ultraviolet light control section 7 which receives a signal from the central control section 1 controls lighting of a lamp (in FIG. 2, lamps 1, 2 . . . n) in the UV lamp unit 15 and thereby ultraviolet light with a wavelength of 300 nm or less is irradiated to the medium 20 under a preferred condition to modify the surface of the medium 20.

The order and the like of the pattern formation and irradiation of the ultraviolet light can be appropriately set similarly to the first embodiment.

As described above, in the printer 10c in accordance with the fourth embodiment, the integral support part 13 is fixed and a medium 20 is reciprocatedly operated to perform pattern formation and irradiation of the ultraviolet light on the medium 20. Therefore, similarly to the second embodiment, functional deterioration can be reduced and a pattern forming apparatus with a high degree of reliability can be obtained. Further, like a seventh embodiment described below, in a case that a pattern forming apparatus is used in processes that other processes are provided in its front and rear positions, the processing on a medium can be performed as one process among processes through which the medium is fed and thus work can be performed efficiently.

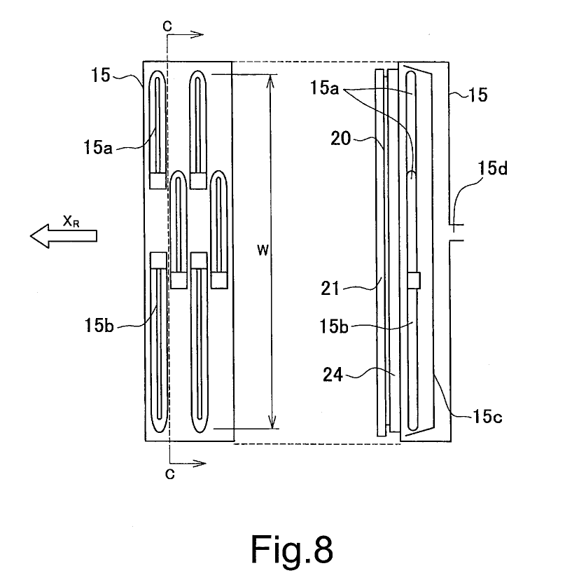

Next, a pattern forming apparatus in a fifth embodiment of the present invention will be described below with reference to FIG. 8. The fifth embodiment is an example in which a plurality of lamps whose lengths are different is disposed in the UV lamp units 15 in the pattern forming apparatuses 10, 10a, 10ab, 10b and 10c in accordance with the first through fourth embodiments.

The left side view in FIG. 8 is a plan view showing an inside of the UV lamp unit 15 which is viewed from an irradiation face side of the ultraviolet light, and its right side view is a cross-sectional view showing the main part when the UV lamp unit 15 in the left side view is cut by the “C-C” line and viewed in a direction shown by the arrows. In FIG. 8, “15a” is a small lamp (ultraviolet light source lamp) and “15b” is a large lamp (ultraviolet light source lamp). In this embodiment, the small lamps 15a in two rows in both of the longitudinal and lateral directions and the large lamps 15b in one row in the longitudinal direction and two rows in the lateral direction are alternately disposed. “W” in the drawing indicates a maximum width of a medium 20 and the lamps 15a and 15b are set to be disposed within a range of the maximum width “W”. “15c” is a reflecting plate which reflects ultraviolet light and “15d” is an exhaust port for exhausting ozone generated in the UV lamp unit 15. Further, “24” is a flexible member in a sheet-like shape which is provided for shielding a leakage light from the UV lamp unit 15. Irradiation to the eyes of an operator is prevented and, in a case that ink is ultraviolet curing-type ink, the ink is prevented from being cured at the nozzle face of the head. Further, even when the flexible member is contacted with the medium 20, the flexible member may not damage the surface of the medium 20. The arrow “XR” in the drawing indicates a direction in which a medium is scanned.

When the ultraviolet light source lamps having different lengths (small lamp 15a and large lamp 15b) are disposed to structure the UV lamp unit 15 like the fifth embodiment, the ultraviolet light can be irradiated in a range corresponding to a shape of pattern which is recorded on a medium 20.

Irradiation of the ultraviolet light is performed so that the ultraviolet light control section 7 shown in FIG. 2 controls lighting of the small lamps 15a and the large lamps 15b.

The ultraviolet light control section 7 receives a signal from the central control section 1 to respectively turn on the small lamps 15a and the large lamps 15b (in FIG. 2, lamps 1, 2 . . . n) in the UV lamp unit 15 as needed. The central control section 1 determines the position and the number of the lamps corresponding to a shape of a desired pattern of a medium and transmits the information to the ultraviolet light control section 7. As a result, for example, depending on the shape of a medium, the small lamps 15a are turned on in two rows, the small lamp 15a in one row and the large lamp 15b in one row are turned on, or only the large lamps 15b are turned on.

As described above, in the fifth embodiment, a plurality of ultraviolet light source lamps (small lamp 15a and large lamp 15b) having different lengths is disposed to structure the UV lamp unit 15 and thereby ultraviolet light is irradiated in a range corresponding to a shape of a desired pattern of a medium and thus energy saving of the apparatus can be attained and its efficiency can be enhanced.

In this embodiment, the ultraviolet light control section 7 is capable of controlling at least one of a light emitting amount and a light emitting time of the ultraviolet light in the UV lamp unit 15 based on the amount of irradiated light of the ultraviolet light and the feeding scan speed which are optimum for modifying the surface of the medium 20. Also in this case, the central control section 1 transmits information of a preferred amount of irradiated light and a preferred feeding scan speed, which are previously set according to a medium and ink to be used or their combination, to the ultraviolet light control section 7 and thereby the ultraviolet light control section 7 controls a light emitting amount or a light emitting time or both of the UV lamp unit 15. Therefore, irradiation of the ultraviolet light can be performed under a preferred condition for a medium.

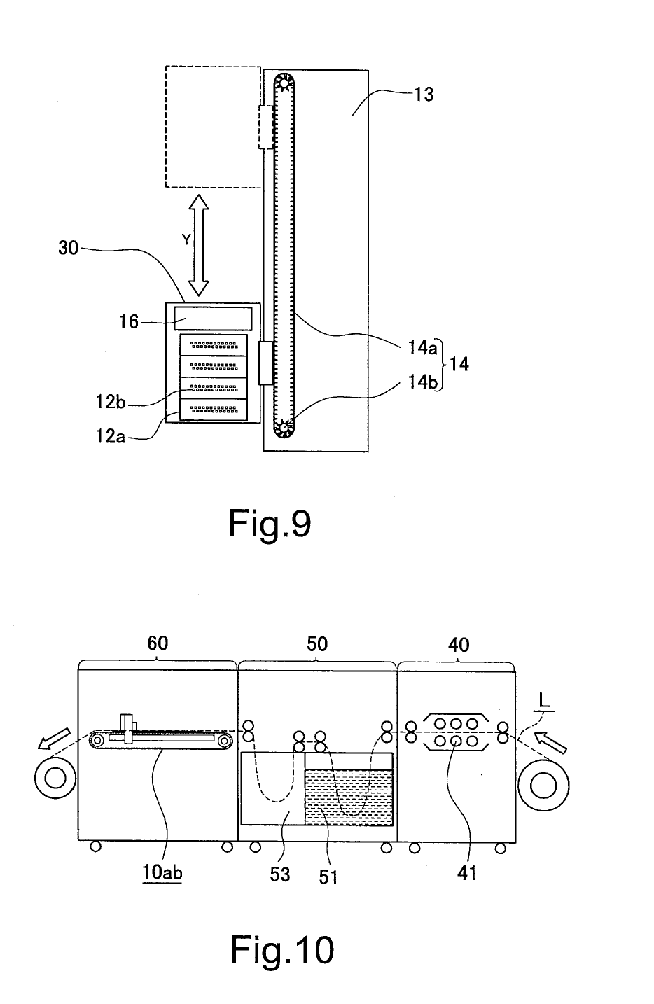

Next, a sixth embodiment of the present invention will be described below with reference to FIG. 9. The sixth embodiment is an example in which ink for pattern formation used in the printer in accordance with the third and the fourth embodiments is set to be ultraviolet curing type ink. In FIG. 9, “12a” is an ink jet head and “12b” is a nozzle for ejecting ink. Further, “14” is a scanning mechanism part which is structured of a scanning belt 14a and scanning pulleys 14b. The scanning pulley 14 is engaged with the scan drive motor 4 (FIG. 2). “16” is an LED lamp unit (light source). “30” is a carriage on which the ink jet heads 12a in four rows and the LED lamp unit 16 are mounted. The arrow “Y” in the drawing is a direction in which the carriage 30 is reciprocatedly moved. The scanning mechanism part 14 is provided in the inside of the integral support part 13 and is mechanically connected with the carriage 30.

Next, its operation will be described below.

The head scanning section 3 which receives a signal from the central control section 1 drives the scan drive motor 4 and thereby the carriage 30 is reciprocatedly moved in the “Y” direction along the side face of the integral support part 13 by the scanning belt 14a which is fed out through the scanning pulleys 14b of the scanning mechanism part 14 in the integral support part 13. In this case, different kinds of inks are ejected from the nozzles 12b of the respective ink jet heads 12a by the head drive section 2 which receives a signal from the central control section 1 to form a pattern on a medium. After that, ultraviolet light with a wavelength of 300 nm or more is irradiated from the LED lamp unit 16 to cure the ejected ink. A wavelength of the ultraviolet light which is preferable to cure the ink is specifically about 360 to 390 nm and thus the wavelength is preferably set within the range.

As described above, an apparatus in which a type of ink cured by ultraviolet light is used may be applied to a pattern forming apparatus in accordance with the present invention.

Next, a seventh embodiment of the present invention will be described below with reference to FIG. 10. The seventh embodiment is an example in which a pattern forming apparatus in accordance with the present invention is provided with a preferable pre-processing part.

In FIG. 10, “40” is a heating treatment part and “41” is a heater member. “50” is an immersing treatment part, “51” is a solvent tank, and “53” is a drying and standby tank. Further, “60” is an ultraviolet irradiation and pattern formation part to which, in this case, the printer 10ab is applied. Further, the arrow in the drawing indicates a flow direction in which a medium is fed and “L” indicates a line along which the medium is fed.

Next, an example of operation will be described below. First, a medium such as a base plate or an image sheet is mounted on a feeding line “L” and is fed to the heating treatment part 40. In the heating treatment part 40, the medium is heated at a preferable temperature by the heater members 41. For example, when the medium is a polyolefin film (such as polyethylene or polypropylene), the temperature is in a range of about 40° C. to 70° C. and the heating time is about 1 to 10 minutes. As the heater member 41, for example, a heater using a far-infrared ray light source or the like is preferable. When the medium is heat-treated in the heat treatment part 40, the effect in the succeeding immersion processing is promoted and, at the time of pattern formation to the medium which will be performed later, wettability of liquid (ink) due to irradiation of ultraviolet light can be further enhanced. Next, the medium heated in the heating treatment part 40 is fed along the feeding line “L” to the immersing treatment part 50 which is adjacent to the heating treatment part 40. When the medium is fed to the inside of the immersing treatment part 50, the medium is firstly fed to the solvent tank 51 to bring into contact with the solvent in the solvent tank 51. An example of the solvent to be used may include ketones, halogenated hydrocarbons, acetone, benzene and hydroquinone. After being brought into contact with the solvent, the medium is dried in the inside of the drying and standby tank 53. The medium is brought into contact with the solvent in the immersing treatment part 50 and thereby, at the time of pattern formation to the medium which will be performed later, wettability of liquid (ink) due to irradiation of ultraviolet light can be further enhanced. In the seventh embodiment, both of the heat treatment part 40 and the immersing treatment part 50 are provided as pre-processing parts, the above-mentioned effects can be further surely attained. After that, the medium is fed to the ultraviolet irradiation and pattern formation part 60 and pattern formation and the irradiation of ultraviolet light are performed in the printer 10ab.

The present invention is not limited to the above-mentioned embodiments. For example, in the first through seventh embodiments, the present invention is applied to an ink jet head printer as a pattern forming apparatus. However, the present invention may be applied to various kinds of apparatuses in which liquid is ejected to a pattern to-be-formed body to perform pattern formation. For example, the present invention may be preferably applied to semiconductor apparatuses or the like.

Further, the medium is not limited to a medium which is used in the above-mentioned embodiments. As a medium, the present invention may be applied to an electronic circuit board, an electronic component, a flat display panel, a color filter, a protective film, rigid or soft sheet face and a plate face, or a projected and recessed face. Further, ink to be used may be selected from color ink containing a pigment and a dye suitable to each medium, electronic material ink such as organic semiconductor material or conductive material, and various functional inks such as a protective film of moisture resistant material and light resistant material. Material of a medium may be selected from various kinds of preferable material such as a recording paper, a film, fabric, metal, glass and resin.

In addition, the pattern forming apparatus in accordance with the present invention is not limited to the examples represented in the above-mentioned drawings and various changes and modifications will be apparent to those skilled in the art from the teachings herein. For example, the shape of the integral support part 13 may be modified to another shape other than the shape shown in the drawings when the liquid ejecting means and the ultraviolet irradiation means are integrally supported by the integral support part 13. Further, in the fifth embodiment, a plurality of ultraviolet light source lamps having a different length is alternately disposed in parallel but another arrangement may be adopted. Further, in the embodiments described above, the integral support part 13 and a medium 20 are reciprocatedly moved but another operation may be adopted when the operation in accordance with the present invention can be performed.

### REFERENCE SIGNS LIST

1 central control section
2 head drive section
3 head scanning section
4 scan drive motor
5 feeding drive section
6 feeding drive motor
7 ultraviolet light source control section
10 printer (pattern forming apparatus)
11 line type ink jet head (liquid ejecting means)
11a nozzle
12, 12a ink jet head (liquid ejecting means)
12b nozzle
13 integral support part
13a guide member
scanning mechanism part
14a scanning belt
14b scanning pulley
15 UV lamp unit (ultraviolet irradiation means which irradiates ultraviolet light)
15a small lamp
15b large lamp
16 LED lamp unit (light source)
17 reflecting plate
19 exhaust port
20 medium
21, 21a medium holding part
22 medium holding part and feeding means
22a endless belt
22b feeding pulley
22c air suction unit
23 feeding means
23a feeding belt
23b pulley
24 flexible member
30 carriage
40 heating treatment part
41 heater member
50 immersing treatment part
51 solvent tank
60 ultraviolet irradiation and pattern formation part
“X_{R}”, “X_{L}” feeding direction
“Y” nozzle arrangement direction of head
“L” line along which medium is fed

1. A pattern forming apparatus comprising:
a liquid ejecting means structured so that liquid is ejected to a pattern to-be-formed body to perform pattern formation;
an ultraviolet irradiation means structured to irradiate ultraviolet light for modifying surface of the pattern to-be-formed body to the pattern to-be-formed body; and
an integral support part which supports both of the liquid ejecting means and the ultraviolet irradiation means.

2. The pattern forming apparatus according to claim 1, wherein the liquid is ink and the liquid ejecting means is an ink jet head.

3. The pattern forming apparatus according to claim 2, wherein the ink jet head is a line type ink jet head which is provided with nozzles for ejecting the ink which are disposed in a line-like shape.

4. The pattern forming apparatus according to claim 2, wherein
the integral support part is moved on an upper side with respect to the pattern to-be-formed body, and
during a moving operation of the integral support part, the ultraviolet irradiation means irradiates ultraviolet light to the pattern to-be-formed body and the ink jet head performs pattern formation on the pattern to-be-formed body.

5. The pattern forming apparatus according to claim 2, wherein
the pattern to-be-formed body is moved on a lower side with respect to the integral support part, and
during a moving operation of the pattern to-be-formed body, the ultraviolet irradiation means irradiates ultraviolet light to the pattern to-be-formed body and the ink jet head performs pattern formation on the pattern to-be-formed body.

6. The pattern forming apparatus according to claim 3, wherein
the integral support part is moved on an upper side with respect to the pattern to-be-formed body, and
during a moving operation of the integral support part, the ultraviolet irradiation means irradiates ultraviolet light to the pattern to-be-formed body and the ink jet head performs pattern formation on the pattern to-be-formed body.

7. The pattern forming apparatus according to claim 3, wherein
the pattern to-be-formed body is moved on a lower side with respect to the integral support part, and
during a moving operation of the pattern to-be-formed body, the ultraviolet irradiation means irradiates ultraviolet light to the pattern to-be-formed body and the ink jet head performs pattern formation on the pattern to-be-formed body.
